(19) United States
(12) Patent Application Publication
(10) Pub. No.: US 2026/0329283 A1
(43) Pub. Date: Oct. 22, 2026

(54) CLEANING ROBOT, AND METHOD FOR CONTROLLING SAME

(71) Applicant: SAMSUNG ELECTRONICS CO., LTD., Suwon-si (KR)

(72) Inventors: Yeonkyu JEONG, Suwon-si (KR); Sinae KIM, Suwon-si (KR)

(73) Assignee: SAMSUNG ELECTRONICS CO., LTD., Suwon-si (KR)

(21) Appl. No.: 19/726,071

(22) Filed: Jun. 30, 2026

Related U.S. Application Data
(63) Continuation of application No. PCT/KR2024/021490, filed on Dec. 30, 2024.

(30) Foreign Application Priority Data
Jan. 23, 2024 (KR) 10-2024-0010522

(51) Int. Cl. G05D 1/246; A47L 11/282; A47L 11/40; F24H 15/464; G05D 1/242; G05D 1/661; G05D 105/10

(52) U.S. Cl. CPC G05D 1/246; A47L 11/282; A47L 11/4011; A47L 11/4038; A47L 11/4066; A47L 11/4069; A47L 11/4091; F24H 15/464; G05D 1/242; A47L 2201/028; A47L 2201/04; A47L 2201/06; G05D 1/661; G05D 2105/10

(57) ABSTRACT

Disclosed herein are a cleaning robot and method for controlling the same. The cleaning robot may include: a main body; a drive assembly configured to move the main body; a cleaning pad provided at a lower portion of the main body and to which a detachable mop is fixed; a rotating portion configured to rotate the cleaning pad; memory configured to store map data corresponding to a area for cleaning; and a processor configured to cause the drive assembly to move the main body based on the map data, and to cause the rotating portion to rotate the cleaning pad to perform a cleaning operation, wherein the processor is further configured to, based on a washing condition of the mop being satisfied during movement of the main body, control the cleaning robot to: transmit a control signal to a docking station to control the docking station to heat water to be used for washing the mop, and control the cleaning robot to dock the main body to the docking station.

### CROSS-REFERENCE TO RELATED APPLICATIONS

This application is a continuation of International Application No. PCT/KR2024/021490, filed on Dec. 30, 2024, which is based on and claims priority to Korean Patent Application No. 10-2024-0010522, filed Jan. 23, 2024, in the Ministry of Intellectual Property Office, Republic of Korea, the disclosures of which are incorporated by reference herein in their entireties.

### BACKGROUND

### 1. Field

The disclosure relates to a cleaning robot and a method for controlling the same.

### 2. Description of Related Art

A cleaning robot may perform wet cleaning by rotating a cleaning pad provided at a lower portion of a main body while autonomously traveling in a cleaning area. For example, a detachable circular mop may be attached to the cleaning pad, and the cleaning pad may be rotated by a motor to clean a floor using the mop.

After completion of cleaning, the cleaning robot returns to a docking station, and the docking station may charge the cleaning robot and perform a mop washing operation.

After the cleaning robot is docked at the docking station, the docking station supplies water stored in the water tank to a heater and heats the water to a preset temperature in order to wash the mop with hot water. Thereafter, the docking station performs the mop washing operation by supplying the hot water to a washing tub. In this instance, a mop sterilization operation may be performed by spraying steam toward the cleaning pad, and, after washing, a mop drying operation may be performed.

As described above, in the related art, because a process for washing the mop, such as heating water, is performed only after the cleaning robot docks at the docking station, the mop washing takes a long time.

One or more embodiments provide a cleaning robot that may perform a mop washing operation by returning to a docking station when a washing condition of a mop is satisfied, and reduce time by preparing hot water used for washing the mop in advance.

### SUMMARY

According to embodiments of the disclosure, a cleaning robot includes: a main body; a drive assembly configured to move the main body; a cleaning pad provided at a lower portion of the main body and to which a detachable mop is attached; a rotating portion configured to rotate the cleaning pad; memory configured to store map data corresponding to an area for cleaning; and a processor configured to cause the drive assembly to move the main body based on the map data, and to cause the rotating portion to rotate the cleaning pad to perform a cleaning operation, wherein the processor is further configured to, based on a washing condition of the mop being satisfied during movement of the main body, cause the cleaning robot to: transmit a control signal to a docking station to control the docking station to heat water to be used for washing the mop, and control the cleaning robot to dock the main body to the docking station.

According to embodiments of the disclosure, a method for controlling a cleaning robot includes: rotating a cleaning pad to which a mop is attached while moving a main body of the cleaning robot based on map data; transmitting a control signal to a docking station based on determining that a washing condition of the mop is satisfied during movement of the main body to control the docking station to heat water to be used for washing the mop; and driving to the docking station to dock to the docking station.

According to embodiments of the disclosure, a non-transitory computer-readable storage medium storing at least one instruction is provided, wherein the at least one instruction, when executed by a processor of a cleaning robot, causes the processor to: perform a cleaning operation by rotating a cleaning pad to which a mop is attached while moving a main body of the cleaning robot based on map data; transmit a control signal to a docking station based on determining that a washing condition of the mop is satisfied during movement of the main body, to control the docking station to heat water to be used for washing the mop; and control the cleaning robot to dock the main body to the docking station.

According to the disclosure, a cleaning robot and a method for controlling the same may perform a mop washing operation by returning the cleaning robot to a docking station when a washing condition of a mop is satisfied, and may reduce time by preparing hot water used for washing the mop in advance.

The effects that may achieved by the disclosure are not limited to the above-mentioned effects, and other effects not mentioned will be clearly understood by one of ordinary skill in the technical art to which the disclosure belongs from the following description.

### BRIEF DESCRIPTION OF THE DRAWINGS

The above and other aspects, features, and advantages of certain embodiments of the present disclosure will be more apparent from the following description taken in conjunction with the accompanying drawings in which:

FIG. 1 is a block diagram illustrating components of a cleaning robot and a docking station according to an embodiment;

FIG. 2 illustrates a bottom surface of the cleaning robot of FIG. 1;

FIG. 3 illustrates a configuration of a docking station for supplying water to be used for washing a mop according to an embodiment;

FIG. 4 illustrates a state in which a cleaning robot is docked at a docking station according to an embodiment;

FIG. 5 is a flowchart illustrating a method for controlling a cleaning robot according to an embodiment;

FIG. 6 is a flowchart illustrating a method for controlling a cleaning robot according to another embodiment;

FIG. 7 is a flowchart illustrating a method for controlling a cleaning robot according to still another embodiment;

FIG. 8 is a flowchart illustrating a method for controlling a cleaning robot according to yet another embodiment.

### DETAILED DESCRIPTION

Various embodiments and the terms used therein are not intended to limit the technology disclosed herein to specific forms, and the disclosure should be understood to include various modifications, equivalents, and/or alternatives to the corresponding embodiments.

In describing the drawings, similar reference numerals may be used to designate similar constituent elements.

A singular expression may include a plural expression unless otherwise indicated herein or clearly contradicted by context.

In the disclosure, phrases, such as “A or B”, “at least one of A and B”, “at least one of A or B”, “A, B or C”, “at least one of A, B and C”, and “at least one of A, B, or C” may include any one or all possible combinations of the items listed together in the corresponding phrase among the phrases. For example, the term “at least one of A, B, and C” may include A, B, C, a combination of A and B, a combination of A and C, a combination of B and C, or a combination of A, B and C.

As used herein, the term “and/or” includes any and all combinations of one or more of the associated listed items.

Terms such as “portion”, “module”, and “member” may be embodied as hardware or software. According to embodiments, a plurality of “portion”, “module”, and “member” may be implemented as a single component or a single “portion”, “module”, and “member” may include a plurality of components.

Terms such as “1st”, “2nd”, “primary”, or “secondary” may be used simply to distinguish an element from other elements, without limiting the element in other aspects (e.g., importance or order).

When an element (e.g., a first element) is referred to as being “(functionally or communicatively) coupled” or “connected” to another element (e.g., a second element), the first element may be connected to the second element, directly (e.g., wired), wirelessly, or through a third element.

It will be understood that when the terms “includes”, “comprises”, “including”, and/or “comprising” are used in the disclosure, they specify the presence of the specified features, figures, steps, operations, components, members, or combinations thereof, but do not preclude the presence or addition of one or more other features, figures, steps, operations, components, members, or combinations thereof.

When a given element is referred to as being “connected to”, “coupled to”, “supported by” or “in contact with” another element, it is to be understood that it may be directly or indirectly connected to, coupled to, supported by, or in contact with the other element. When a given element is indirectly connected to, coupled to, supported by, or in contact with another element, it is to be understood that it may be connected to, coupled to, supported by, or in contact with the other element through a third element.

It will also be understood that when an element is referred to as being “on” another element, it may be directly on the other element or intervening elements may also be present.

Hereinafter, embodiments of the disclosure will be described in detail with reference to accompanying drawings. Embodiments described herein are non-limiting example embodiments, and thus, the disclosure is not limited thereto and may be realized in various other forms. One or more features of at least one embodiment provided herein may be applied to one or more other embodiments provided herein or not provided but consistent with the disclosure. Also, at least one embodiment provided herein is not excluded from being associated with one or more features of another example or another embodiment also provided herein or not provided herein but consistent with the disclosure.

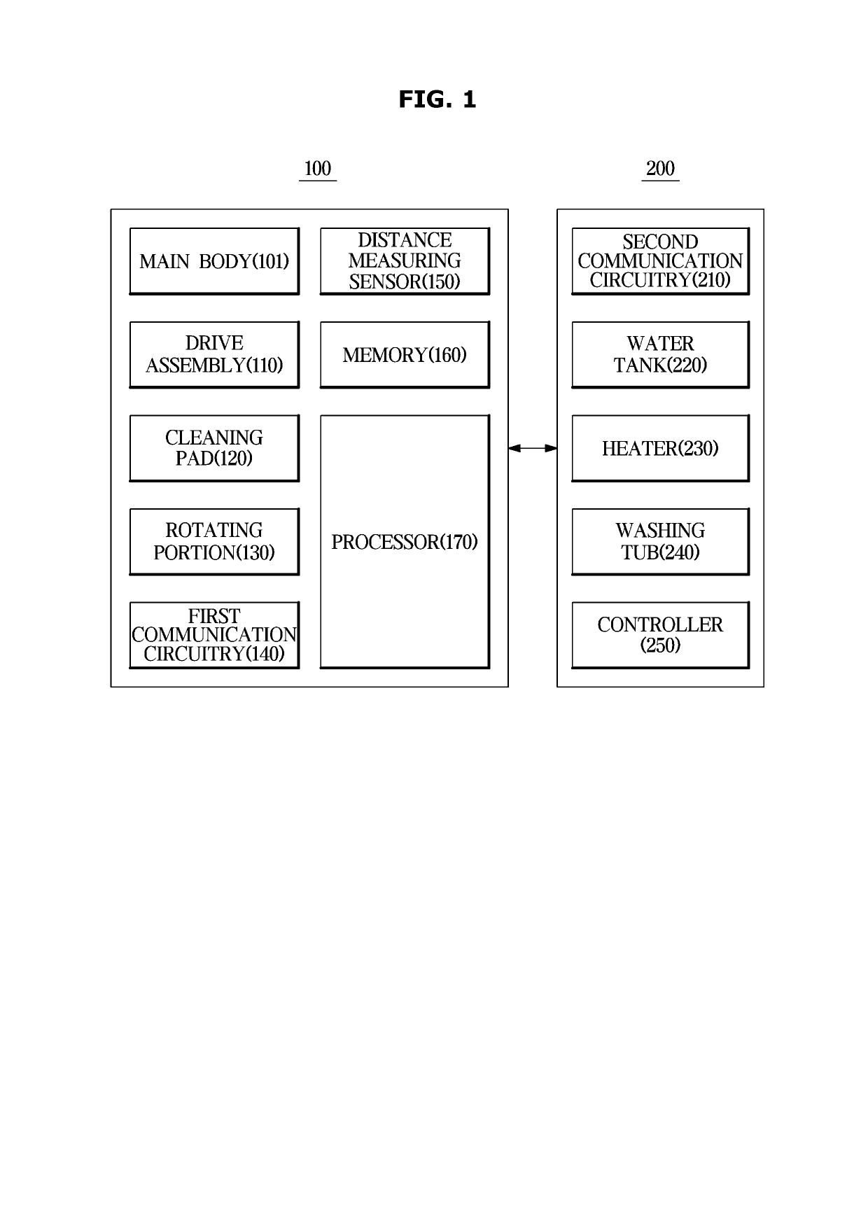

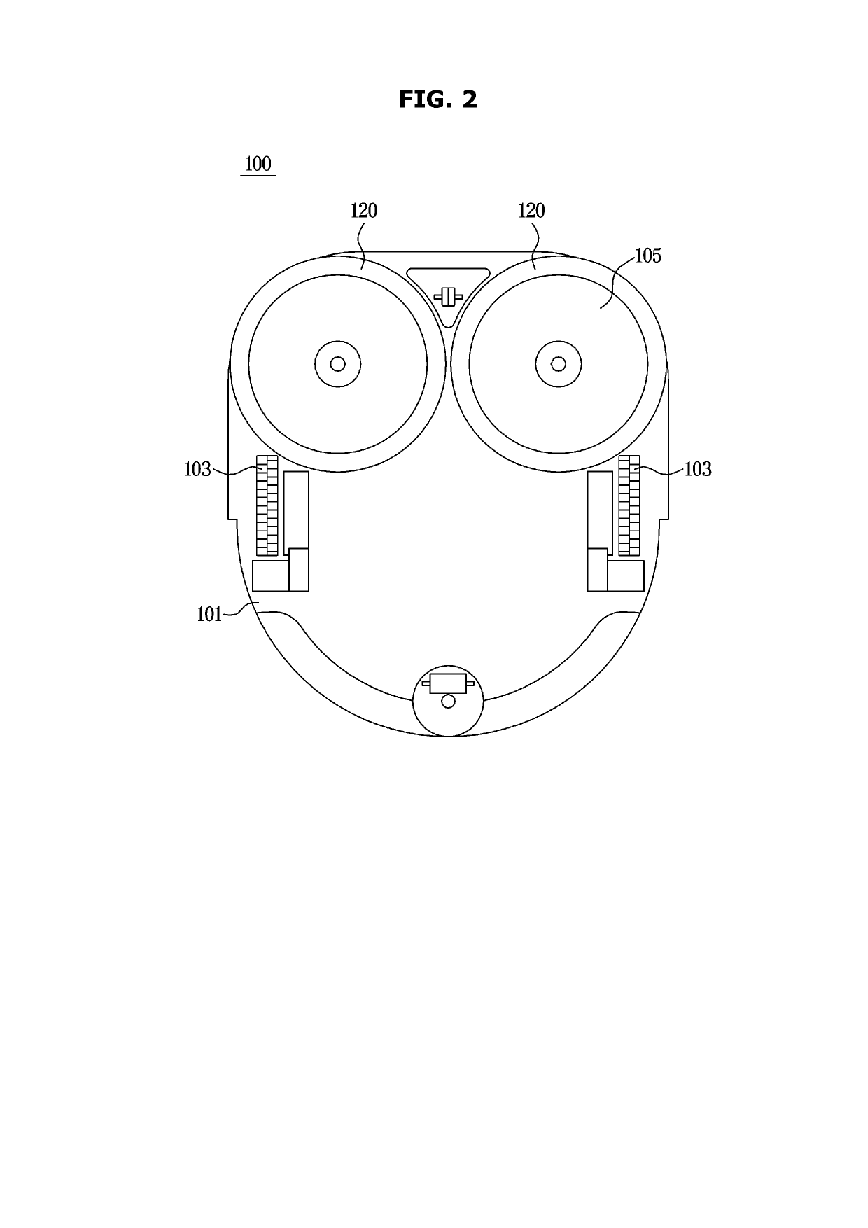

FIG. 1 is a block diagram illustrating components of a cleaning robot and a docking station according to an embodiment. FIG. 2 illustrates a bottom surface of the cleaning robot of FIG. 1.

Referring to FIGS. 1 and 2, a cleaning robot 100 may include a main body 101, a drive assembly 110, a cleaning pad 120, a rotating portion 130, first communication circuitry 140, a distance measuring sensor 150, a memory 160, and a processor 170. The cleaning robot 100 may include a drum brush for scattering dirt, a dust suction fan for drawing in the dust, a dust container for storing the drawn dust, various sensors (e.g., an ultrasonic sensor, an infrared sensor, an RF sensor, etc.) for detecting surrounding objects, a camera for image acquisition, and the like.

The main body 101, for example, may have a circular shape and may travel in the cleaning area by the drive assembly 110.

The drive assembly 110 may include a wheel 103 for moving the main body 101 and a motor for driving the wheel 103.

The cleaning pad 120 may be positioned at a lower portion of the main body 101, and a detachable mop 105 may be attached thereto. The mop 105 fixed to the cleaning pad 120 may wet-clean a floor surface while contacting the floor surface in the cleaning area. To this end, moisture may be supplied to the mop 105 fixed to the cleaning pad 120 from a moisture supplier provided in the cleaning robot 100.

The rotating portion 130 may include a motor for rotating the cleaning pad 120. As the cleaning pad 120 is rotated by the rotating portion 130, contaminants on the floor surface may be effectively removed.

The first communication circuitry 140 may perform wireless communication with external devices such as a remote controller, a user terminal, and a docking station 200. For example, wireless internet technologies, such as wireless local area network (WLAN), Wi-Fi, wireless broadband (WiBro), worldwide interoperability for microwave access (WiMAX), high speed downlink packet access (HSDPA), IEEE 802.16, long term evolution (LTE), and wireless mobile broadband service (WMBS) may be used for the wireless communication method. In addition, short-range wireless communication technologies, such as Bluetooth, radio frequency identification (RFID), infrared data association (IrDA), ultra wideband (UWB), and ZigBee may be used for the wireless communication method. The first communication circuitry 140 may be included in the processor 170 to be described below.

The distance measuring sensor 150 may detect positions of the main body 101 and the docking station 200 on a map of the cleaning area. The distance measuring sensor 150 may include an ultrasonic sensor, a radar sensor, an infrared sensor, a light detection and ranging (LiDAR) sensor, and the like.

In this instance, the processor 170 may measure a distance between the main body 101 and the docking station 200 based on the detected information received from the distance measuring sensor 150. That is, the processor 170 may measure the distance between the main body 101 and the docking station 200 by comparing the position of the main body 101 with the position of the docking station 200 received from the distance measuring sensor 150.

In another example, the distance measuring sensor 150 may include a processor. In this case, the distance measuring sensor 150 may measure the distance between the main body 101 and the docking station 200 by detecting the positions of the main body 101 and the docking station 200 on the map of the cleaning area or by transmitting and receiving signals to and from the docking station 200.

The above-described distance between the main body 101 and the docking station 200 and a current moving speed of the main body 101 may be used when the processor 170 calculates an estimated time required for the main body 101 (or the cleaning robot 100) to arrive at the docking station 200.

The memory 160 may store programs, applications, and data for operation of the cleaning robot 100, and may store data generated by the processor 170. The memory 160 may store a cleaning algorithm, map data of the cleaning area, various user interfaces (UIs), a movement path of the cleaning robot 100 during a cleaning operation, a cleaning algorithm used for each path, various setting values, control signals, and the like.

The memory 160 may include non-volatile memory, such as read only memory (ROM) and flash memory for long-term data storage. The memory may include volatile memory, such as static random access memory (S-RAM) and dynamic random access memory (D-RAM) for temporarily storing data.

The processor 170 may control overall operations and functions of the cleaning robot 100, and the functions of the cleaning robot 100 may be processed by a single processor 170 or by a combination of a plurality of processors 170.

The processor 170 may be implemented as a digital signal processor (DSP) or a microprocessor. However, the processor 170 is not limited thereto and may include at least one of a central processing unit (CPU), a micro controller unit (MCU), a micro processing unit (MPU), a controller, an application processor (AP), a communication processor (CP), or an advanced RISC machine (ARM) processor. In addition, the processor 170 may be implemented in the form of a system on chip (SoC), a large scale integration (LSI), or a field programmable gate array (FPGA), in which a processing algorithm is embedded.

The processor 170 may include logic circuitry and arithmetic circuitry in hardware. The processor 170 may control the electrically connected components of the cleaning robot 100 using programs, instructions, and data stored in the memory 160 for operation of the cleaning robot 100. The processor 170 and the memory 160 may be implemented as separate chips or as a single chip.

The processor 170 may cause the drive assembly 110 to move the main body 101 based on map data of the cleaning area, and may cause the rotating portion 130 to rotate the cleaning pad 120 so that a cleaning operation is performed.

The map data of the cleaning area may be data obtained by mapping the cleaning area using sensors or a camera of the cleaning robot 100 and storing the mapped area as data. Specifically, the cleaning robot 100 may generate the map data by collecting and processing data in real time while traveling in the cleaning area using an infrared sensor, a contact sensor, a laser scanner, an accelerometer, a gyroscope, a camera, and the like. Simultaneous localization and mapping (SLAM) technology may be used to estimate a position of the cleaning robot 100 and generate the map data by using sensor data.

The processor 170 may determine whether a washing condition of the mop 105 is satisfied during movement of the main body 101.

The processor 170 may determine that the washing condition of the mop 105 is satisfied when an area cleaned in the cleaning area based on the map data exceeds a preset area. For example, in a case where the preset area is 20 square meters and the cleaning robot 100 has currently cleaned an area of 25 square meters, the processor 170 may determine that the washing condition of the mop 105 is satisfied.

The processor 170 may determine that the washing condition of the mop 105 is satisfied when a usage time of the cleaning pad 120 exceeds a preset usage time. For example, in a case where the preset usage time is 30 minutes and a current usage time of the cleaning pad 120 is 35 minutes, the processor 170 may determine that the washing condition of the mop 105 is satisfied.

The processor 170 may determine that the washing condition of the mop 105 is satisfied when cleaning in the cleaning area is completed based on the map data. The map data of the cleaning area may be used for the cleaning robot 100 to identify the surrounding environment and determine a movement path. For example, when the cleaning robot 100 performs cleaning while travelling through the cleaning area based on the map data, the processor 170 may analyze the map data to determine whether all cleaning has been completed.

The processor 170 may determine that the washing condition of the mop 105 is satisfied when a washing command for the mop 105 (a mop washing command) is received via an external device or a user interface. For example, a user may transmit a mop washing command to the cleaning robot 100 by voice or by pressing a button through a user terminal. In addition, the user may transmit the mop washing command by voice or by pressing a button through a user interface provided on the cleaning robot 100.

In response to the washing condition of the mop 105 being satisfied during movement of the main body 101, the processor 170 may generate a control signal and transmit the control signal to the docking station 200 so that water to be used for washing the mop 105 is pre-heated by the docking station 200.

Here, the control signal may include a command for the docking station 200 to pre-heat water to be used for washing the mop 105. In response to receiving the control signal, the docking station 200 may perform an operation based on the control signal.

After generating and transmitting the control signal to the docking station 200, the processor 170 may return the main body 101 to the docking station 200.

The processor 170 may calculate an estimated time required for the main body 101 (or the cleaning robot 100) to arrive at the docking station 200 by using the distance between the main body 101 and the docking station 200 and a current moving speed of the main body 101.

As described above, the processor 170 may measure the distance between the main body 101 and the docking station 200 by comparing the position of the main body 101 with the position of the docking station 200 received from the distance measuring sensor 150.

The docking station 200 may include second communication circuitry 210, a water tank 220, a heater 230, a washing tub 240, and a controller 250. Here, the controller 250 may control overall operations and functions of the docking station 200 and may include at least one processor.

Hereinafter, the docking station 200 will be described first, and then the processor 170 will be described subsequently.

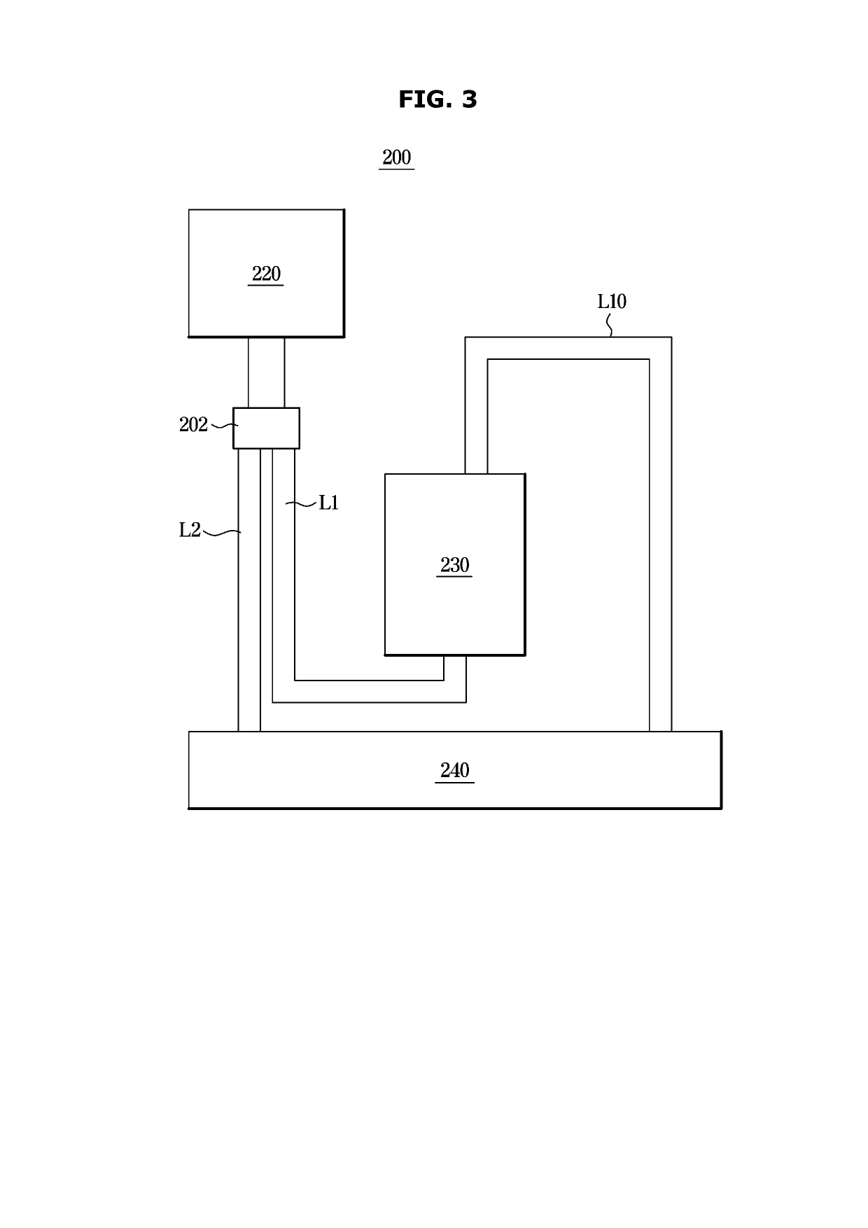

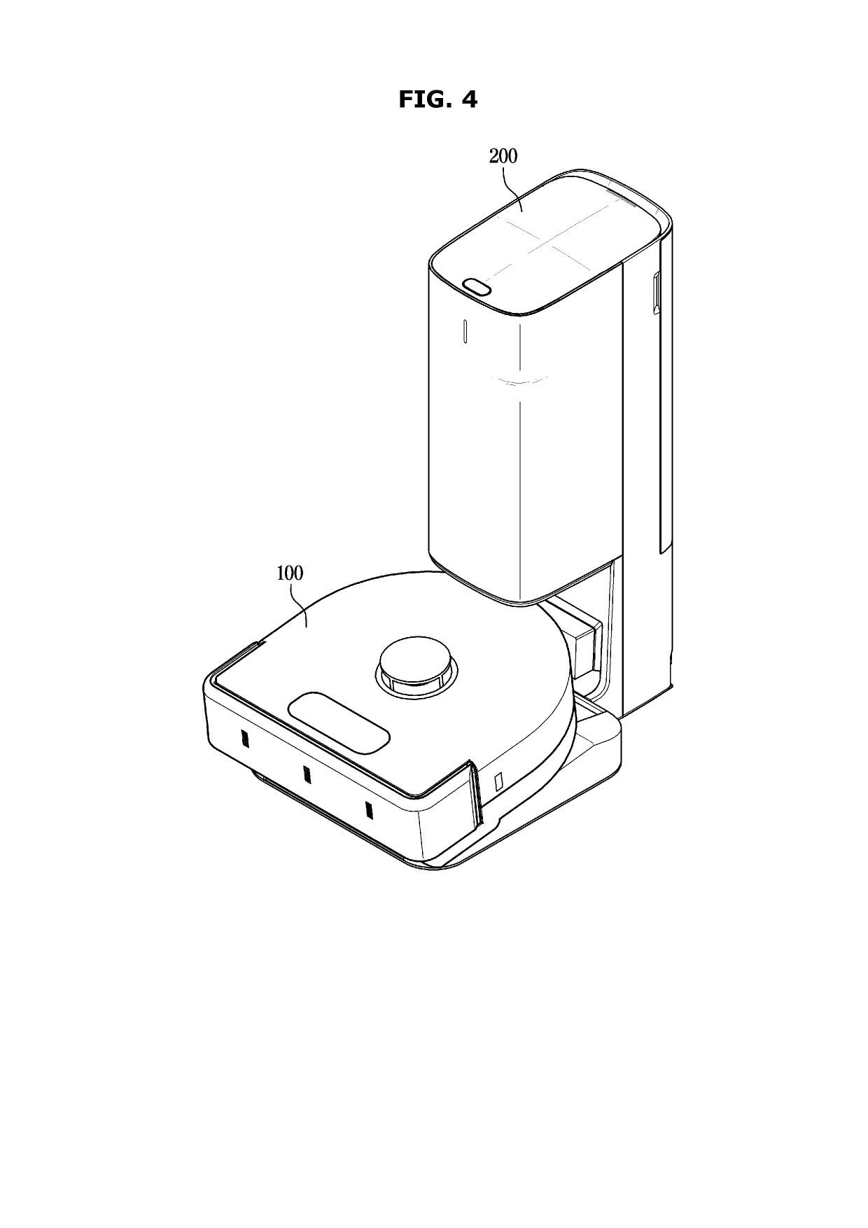

FIG. 3 illustrates a configuration of a docking station for supplying water to be used for washing a mop according to an embodiment. FIG. 4 illustrates a state in which a cleaning robot is docked at a docking station according to an embodiment.

Referring to FIGS. 3 and 4, the water tank 220 of the docking station 200 may be connected to the heater 230 through a first connection line L1, and the heater 230 may be connected to the washing tub 240 through a hot-water line L10.

In addition, the water tank 220 may be connected to the washing tub 240 through a second connection line L2.

During general washing, water in the water tank 220 may be supplied to the washing tub 240 through the second connection line L2.

During hot-water washing, water in the water tank 220 may be supplied to the heater 230 through the first connection line L1. After being heated by the heater 230 to a temperature suitable for washing the mop 105, water may be supplied to the washing tub 240 through the hot-water line L10. In the embodiment, it is assumed that the mop 105 is washed with hot water.

Water may be selectively supplied to the first connection line L1 or the second connection line L2 by controlling a valve 202.

The controller 250 may receive a control signal from the cleaning robot 100 via the second communication circuitry 210. The controller 250 may allow supply of water stored in the water tank 220 to the heater 230, and allow the heater 230 to heat water to be used for washing the mop 105 based on the control signal. In addition, the controller 250 may allow supply of the water heated by the heater 230 to the washing tub 240 to perform washing of the mop 105.

A washing plate may be provided in the washing tub 240, and, after the cleaning robot 100 docks at the docking station 200, the mop may be washed by rubbing the mop 105 against the washing plate while the cleaning pad 120 of the cleaning robot 100 rotates.

In an embodiment, in response to a washing condition of the mop 105 being satisfied during movement of the main body 101, the processor 170 may transmit a first control signal to the docking station 200 so that water is pre-heated by the docking station 200 to a first temperature (e.g., 30°C to 40°C) lower than a temperature of water used for washing the mop 105 (e.g., 45°C to 50°C). That is, the first control signal may include a command for the docking station 200 to heat the water to the first temperature.

In this case, after receiving the first control signal via the second communication circuitry 210, the docking station 200 may supply water stored in the water tank 220 to the heater 230 based on the first control signal, and may heat the water using the heater 230 so as to reach the first temperature.

In addition, when the main body 101 of the cleaning robot 100 docks at the docking station 200, the processor 170 may transmit a second control signal to the docking station 200. Based on the second control signal, the docking station 200 may further heat the water that has reached the above-described first temperature by using the heater 230 so that the water reaches a second temperature (e.g., 45°C to 50°C), which is the temperature of water used for washing the mop 105. Then, the docking station 200 may supply the water that has reached the second temperature to the washing tub 240 to perform washing of the mop 105.

In another example, when the washing condition of the mop 105 is satisfied during movement of the main body 101, the processor 170 may transmit a first control signal to the docking station 200 so that water is pre-heated by the docking station 200 to the first temperature (e.g., 30°C to 40°C) lower than the temperature of water used for washing the mop 105 (e.g., 45°C to 50°C).

Further, while the main body 101 is returning to the docking station 200, in a case where the distance between the main body 101 and the docking station 200 is less than a preset distance or an estimated time required for the main body 101 to arrive at the docking station 200 is less than a preset time, the processor 170 may transmit a second control signal to the docking station 200.

Based on the second control signal, the docking station 200 may further heat the water that has reached the above-described first temperature by using the heater 230 so that the water reaches the second temperature (e.g., 45°C to 50°C), which is the temperature of water used for washing the mop 105.

As such, because water is pre-heated to the temperature of water used for washing the mop 105 before the main body 101 of the cleaning robot 100 docks at the docking station 200, the time required for washing the mop 105 may be reduced.

Thereafter, when the main body 101 docks at the docking station 200, the processor 170 may transmit a third control signal to the docking station 200. The third control signal includes a command for the docking station 200 to wash the mop 105 by supplying the water that has reached the above-described second temperature to the washing tub 240.

Specifically, based on the third control signal, the docking station 200 may supply the washing tub 240 with the water heated by the heater 230 and having reached the second temperature through the hot-water line L10. The docking station 200 may perform washing of the mop 105 in communication with the cleaning robot 100 by rotating the cleaning pad 120 for a set time while the mop 105 rubs against a washing plate provided in the washing tub 240. The docking station 200 may perform a mop sterilization operation by spraying steam toward the cleaning pad 120, and, after washing, may perform a mop drying operation and a wastewater draining operation of the washing tub 240.

In still another example, when the washing condition of the mop 105 is satisfied during movement of the main body 101 and, at the same time, the distance between the main body 101 and the docking station 200 is less than a preset distance or the estimated time required for the main body 101 to arrive at the docking station 200 is less than a preset time, the processor 170 may generate a first control signal and transmit the first control signal to the docking station 200 so that water is pre-heated by the docking station 200 to a second temperature, which is the temperature of water used for washing the mop 105.

As such, when a preset condition is satisfied before the main body 101 docks at the docking station 200, the docking station 200 may immediately pre-heat water to the temperature of water used for washing the mop 105 (e.g., 45°C to 50°C) without going through a process of heating water to the first temperature, thereby simplifying the process for washing the mop 105.

Thereafter, when the main body 101 docks at the docking station 200, the processor 170 may generate a second control signal and transmit the second control signal to the docking station 200 so that the docking station 200 supplies the water that has reached the second temperature to the washing tub 240 to perform washing of the mop 105.

In yet another example, in response to the washing condition of the mop 105 being satisfied during movement of the main body 101, the processor 170 may transmit a first control signal to the docking station 200 so that water to be used for washing the mop 105 is supplied from the water tank 220 to the heater 230.

In this case, the first control signal does not include a command for the docking station 200 to heat the water, but only includes a command to supply water to be used for washing the mop 105 from the water tank 220 to the heater 230.

Thereafter, when the main body 101 docks at the docking station 200, the processor 170 may transmit a second control signal to the docking station 200 so that the docking station 200 heats the water using the heater 230 to a second temperature, which is the temperature of water used for washing the mop 105, and supplies the water that has reached the second temperature to the washing tub 240 to perform washing of the mop 105.

For example, in a case where water may be heated quickly according to a capacity and a material of the heater 230, the water may be only supplied to the heater 230 without being pre-heated by the heater 230 as described above. Then, when the main body 101 docks at the docking station 200, by rapidly heating the water to the above-described second temperature using the heater 230 to perform washing of the mop 105, energy consumption may be reduced and washing time may be minimized.

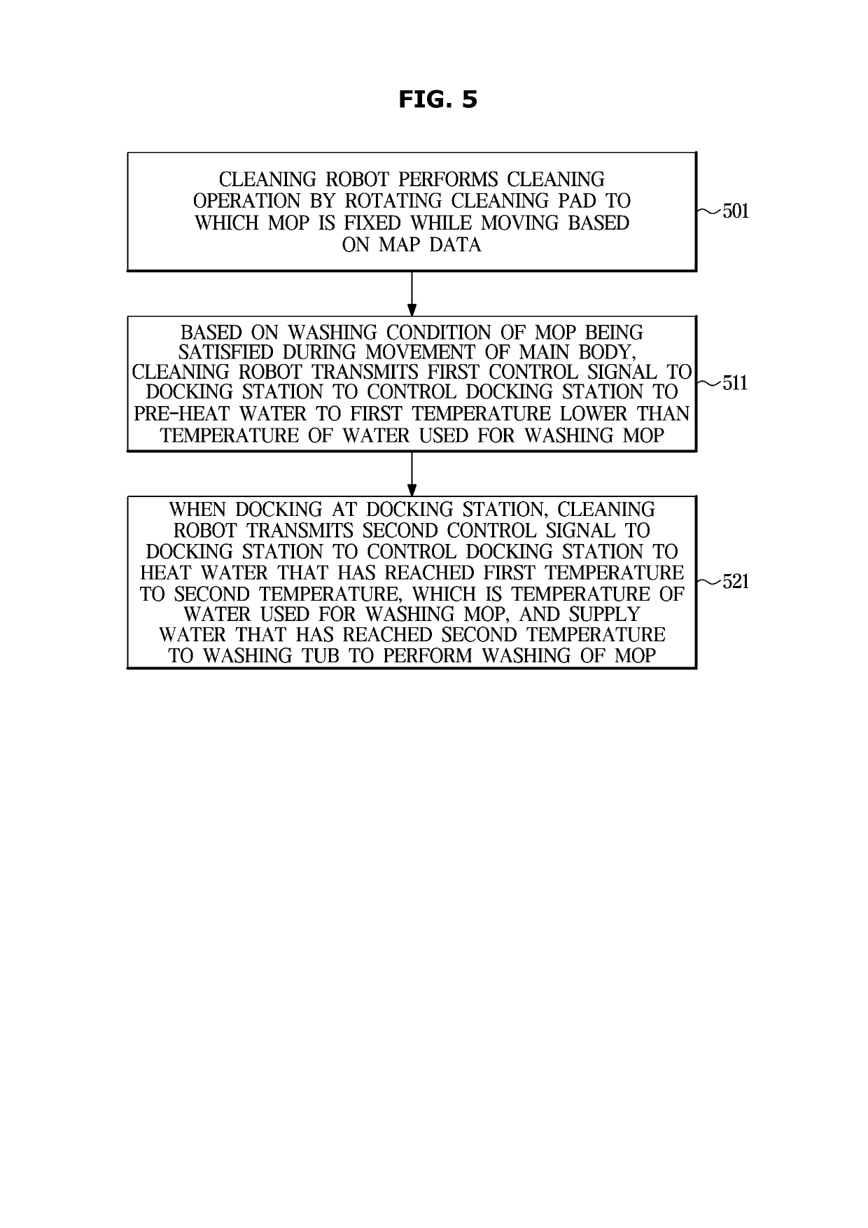

FIG. 5 is a flowchart illustrating a method for controlling a cleaning robot according to an embodiment.

Referring to FIG. 5, in operation 501, the cleaning robot 100 performs a cleaning operation by rotating the cleaning pad 120 to which the mop 105 is fixed while moving based on map data.

In operation 511, in response to a washing condition of the mop 105 being satisfied during movement of the main body 101, the cleaning robot 100 transmits a first control signal to the docking station 200 so that water is pre-heated by the docking station 200 to a first temperature lower than a temperature of water used for washing the mop 105.

The cleaning robot 100 may determine that the washing condition of the mop 105 is satisfied when at least one of the following is satisfied: an area cleaned in the cleaning area exceeds a preset area based on the map data, a usage time of the cleaning pad 120 exceeds a preset usage time, cleaning is completed in the cleaning area based on the map data, or a washing command for the mop 105 is received via a user interface.

After receiving the first control signal, the docking station 200 may supply water stored in the water tank 220 to the heater 230 based on the first control signal, and may heat the water using the heater 230 so that the water reaches the first temperature.

In operation 521, when docking at the docking station 200, the cleaning robot 100 transmits a second control signal to the docking station 200 so that the docking station 200 heats the water that has reached the above-described first temperature to a second temperature, which is the temperature of water used for washing the mop 105, and supplies the water that has reached the second temperature to the washing tub 240 to perform washing of the mop 105.

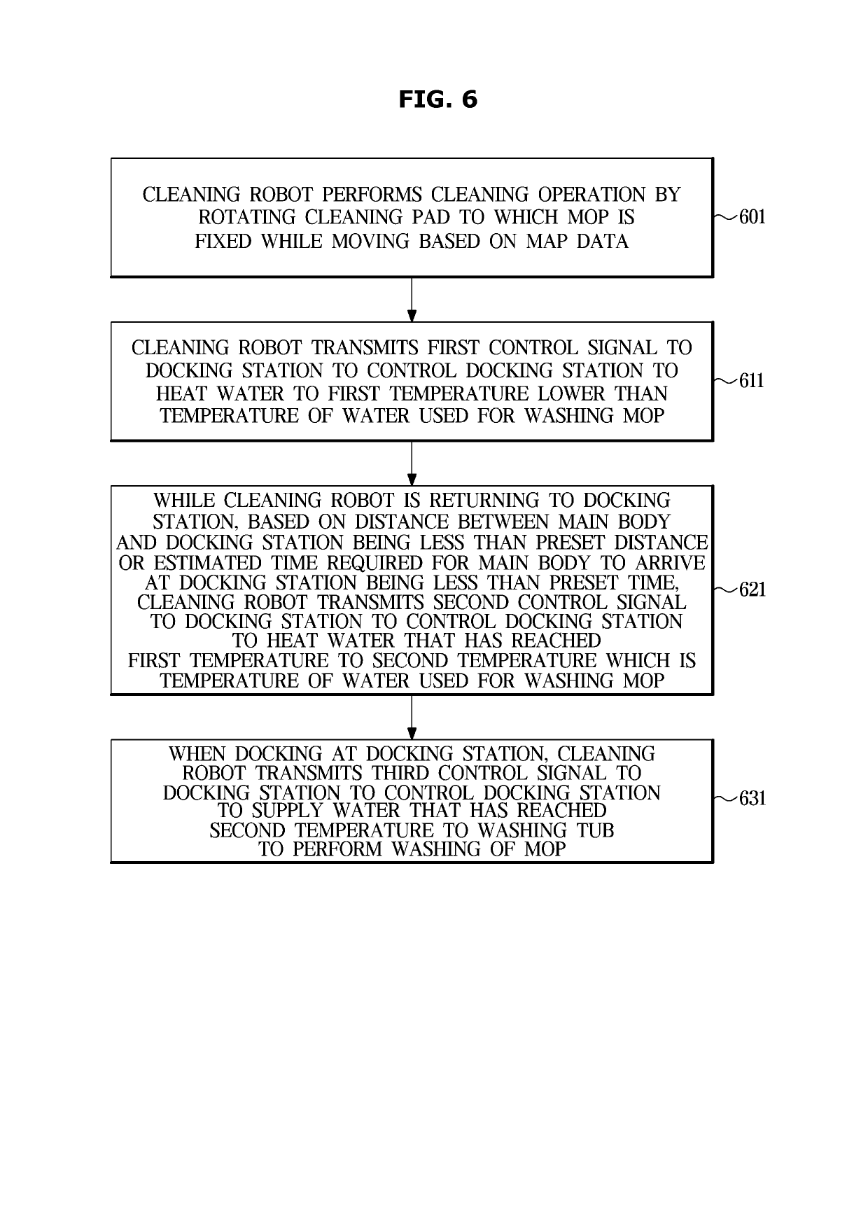

FIG. 6 is a flowchart illustrating a method for controlling a cleaning robot according to another embodiment.

Referring to FIG. 6, in operation 601, the cleaning robot 100 performs a cleaning operation by rotating the cleaning pad 120 to which the mop 105 is fixed while moving based on map data.

In operation 611, the cleaning robot 100 transmits a first control signal to the docking station 200 so that water is pre-heated by the docking station 200 to a first temperature lower than a temperature of water used for washing the mop 105.

In operation 621, while the cleaning robot 100 is returning to the docking station 200, in a case where a distance between the main body 101 and the docking station 200 is less than a preset distance or an estimated time required for the main body 101 to arrive at the docking station 200 is less than a preset time, the cleaning robot 100 transmits a second control signal to the docking station 200 so that the docking station 200 heats the water that has reached the above-described first temperature to a second temperature, which is the temperature of water used for washing the mop 105.

In operation 631, when docking at the docking station 200, the cleaning robot 100 transmits a third control signal to the docking station 200 so that the docking station 200 supplies the water that has reached the above-described second temperature to the washing tub 240 to perform washing of the mop 105.

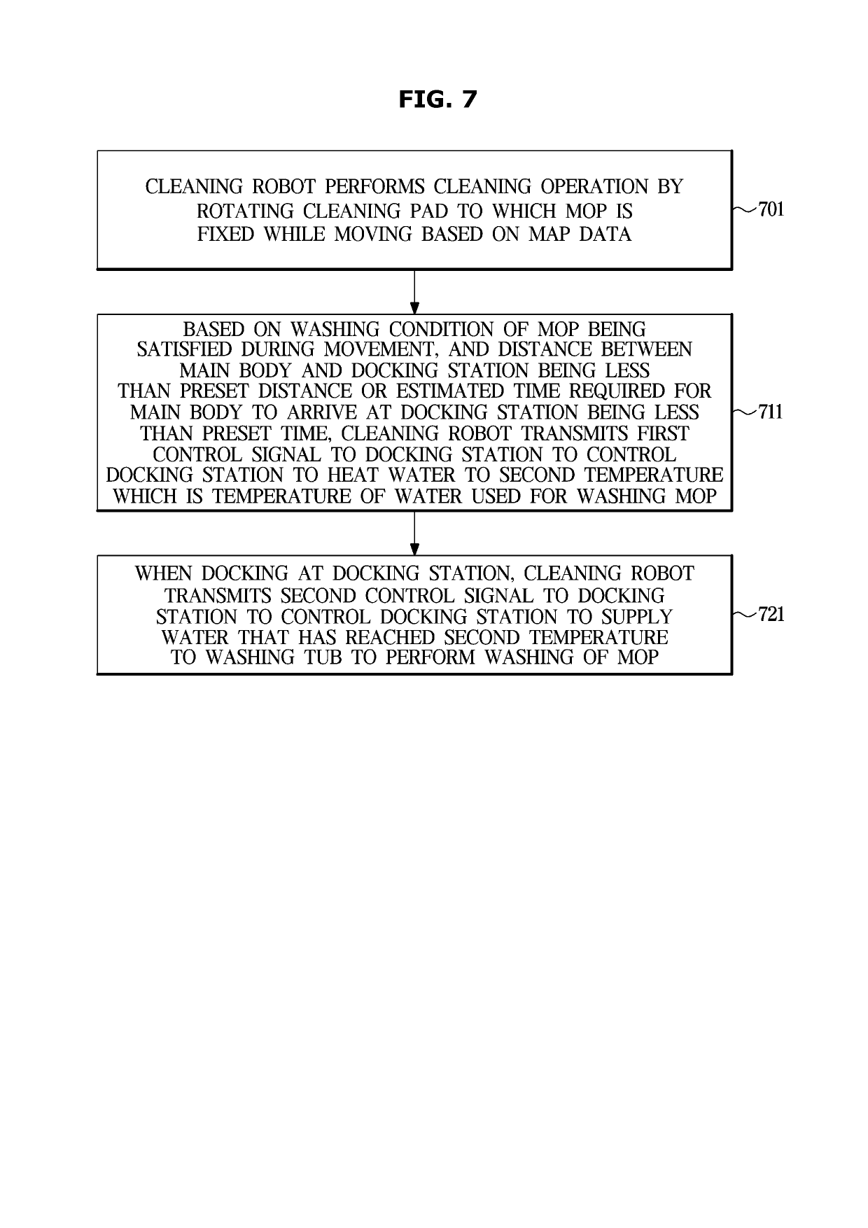

FIG. 7 is a flowchart illustrating a method for controlling a cleaning robot according to still another embodiment.

Referring to FIG. 7, in operation 701, the cleaning robot 100 performs a cleaning operation by rotating the cleaning pad 120 to which the mop 105 is fixed while moving based on map data.

In operation 711, when a washing condition of the mop 105 is satisfied during movement and, at the same time, a distance between the main body 101 and the docking station 200 is less than a preset distance or an estimated time required for the main body 101 to arrive at the docking station 200 is less than a preset time, the cleaning robot 100 transmits a first control signal to the docking station 200 so that water is pre-heated by the docking station 200 to a second temperature, which is the temperature of water used for washing the mop 105.

In operation 721, when docking at the docking station 200, the cleaning robot 100 transmits a second control signal to the docking station 200 so that the docking station 200 supplies the water that has reached the second temperature to the washing tub 240 to perform washing of the mop 105.

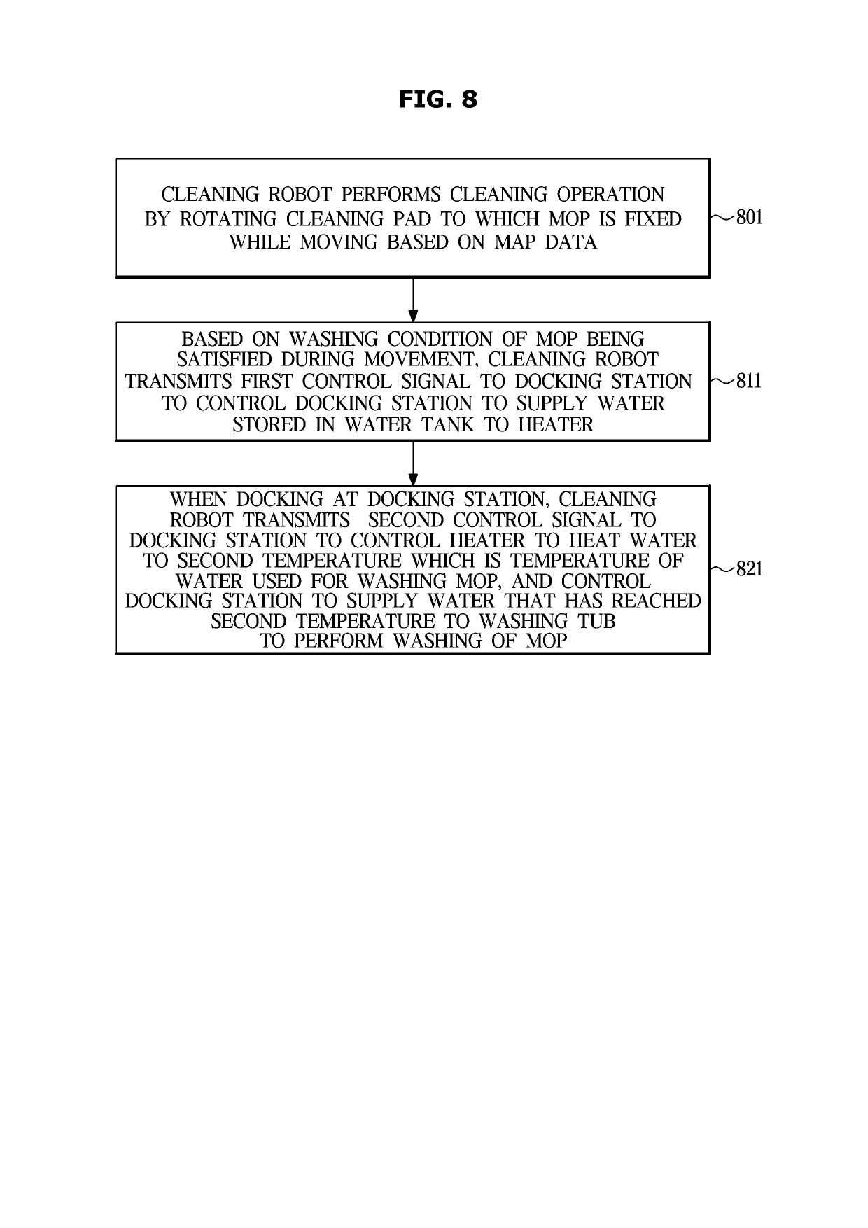

FIG. 8 is a flowchart illustrating a method for controlling a cleaning robot according to yet another embodiment.

In operation 801, cleaning robot 100 performs a cleaning operation by rotating the cleaning pad 120 to which the mop 105 is fixed while moving based on map data.

In operation 811, in response to a washing condition of the mop 105 being satisfied during movement, the cleaning robot 100 transmits a first control signal to the docking station 200 so that the docking station 200 supplies water stored in the water tank 220 to the heater 230.

In operation 821, when docking at the docking station 200, the cleaning robot 100 transmits a second control signal to the docking station 200 so that the water is heated by the heater 230 to a second temperature, which is the temperature of water used for washing the mop 105, and the water that has reached the second temperature is supplied to the washing tub to perform mop washing.

According to embodiments of the disclosure, a cleaning robot includes: a main body; a drive assembly configured to move the main body; a cleaning pad provided at a lower portion of the main body and to which a detachable mop is attached; a rotating portion configured to rotate the cleaning pad; memory configured to store map data corresponding to an area for cleaning; and a processor configured to cause the drive assembly to move the main body based on the map data, and to cause the rotating portion to rotate the cleaning pad to perform a cleaning operation, wherein the processor is further configured to, based on a washing condition of the mop being satisfied during movement of the main body, cause the cleaning robot to: transmit a control signal to a docking station to control the docking station to heat water to be used for washing the mop, and control the cleaning robot to dockn the main body to the docking station.

The processor may be configured to cause the cleaning robot to determine that the washing condition of the mop is satisfied based on a size of a cleaned area in the area exceeding a preset size based on the map data.

The processor may be configured to cause the cleaning robot to determine that the washing condition of the mop is satisfied based on a usage time of the cleaning pad exceeding a preset usage time.

The processor may be configured to cause the cleaning robot to determine that the washing condition of the mop is satisfied based on completion of cleaning in the cleaning area based on the map data.

The processor may be configured to cause the cleaning robot to determine that the washing condition of the mop is satisfied based on a washing command for the mop being received via an external device or a user interface.

The processor may be configured to cause the cleaning robot to: based on a washing condition of the mop being satisfied during movement of the main body, (1) transmit a first control signal to the docking station to control the docking station to heat the water to a first temperature, the first temperature being lower than a second temperature of water used for washing the mop; and (2) return to the docking station; and based on the main body being docked at the docking station, control the cleaning robot to transmit a second control signal to the docking station to control the docking station to (3) heat the water to the second temperature and (4) supply a washing tub with the water having reached the second temperature to wash the mop.

The processor may be configured to cause the cleaning robot to: based on the washing condition of the mop being satisfied during movement and based on a distance between the cleaning robot and the docking station, transmit the control signal to the docking station.

The cleaning robot may include: at least one of an ultrasonic sensor, a radar sensor, an infrared sensor, or a light detection and ranging (LiDAR) sensor, and the processor may be configured to obtain information on the distance between the cleaning robot and the docking station based on information obtained through the at least one of the ultrasonic sensor, the radar sensor, the infrared sensor, or the light detection or ranging (LiDAR) sensor..

The processor may be configured to cause the cleaning robot to: based on the washing condition of the mop being satisfied during movement of the main body and based on at least one of the distance between the cleaning robot and the docking station being less than a preset distance or the estimated time required for the cleaning robot to arrive at the docking station being less than a preset time, transmit the control signal to the docking station to control the docking station to heat the water to a temperature of water used for washing the mop, and wherein the processor is configured to obtain the estimated time based on the distance and a moving speed of the cleaning robot

The processor may be configured to cause the cleaning robot to: based on the washing condition of the mop being satisfied during movement of the main body, (1) transmit a first control signal to the docking station to control the docking station to heat water to a first temperature, the first temperature being lower than a second temperature of water used for washing the mop, and (2) return to the docking station; and based on, while the main body returns to the docking station, at least one of the distance between the cleaning robot and the docking station being less than a preset distance or the estimated time required for the cleaning robot to arrive at the docking station being less than a preset time, transmit a second control signal to the docking station to control the docking station to heat the water to the second temperature, wherein the processor is configured to obtain the estimated time based on the distance and a moving speed of the cleaning robot

The processor may be configured to cause the cleaning robot to: based on the main body being docked at the docking station, transmit a third control signal to the docking station to control the docking station to supply a washing tub with the water to wash the mop.

According to embodiments of the disclosure, a method for controlling a cleaning robot includes: rotating a cleaning pad to which a mop is attached while moving a main body of the cleaning robot based on map data; transmitting a control signal to a docking station based on determining that a washing condition of the mop is satisfied during movement of the main body to control the docking station to heat water to be used for washing the mop; and driving to the docking station to dock to the docking station.

The method may include: determining the washing condition of the mop is satisfied based on at least one of: an size of a cleaned area in an area for cleaning of the map data exceeding a preset size, a usage time of the cleaning pad exceeding a preset usage time, a completion of cleaning in the cleaning area based on the map data, or a reception of a washing command for the mop via an external device or a user interface.

The method may include: based on determining that the washing condition of the mop is satisfied during movement of the main body, (1) transmitting a first control signal to control the docking station to heat the water to a first temperature, the first temperature being lower than a second temperature of water used for washing the mop; and (2) returning to the docking station; and based on the main body being docked at the docking station, transmitting a second control signal to the docking station to control the docking station to (3) heat the water to the second temperature and (4) supply a washing tub with the water having reached the second temperature to wash the mop.

The method may include: based on determining that the washing condition of the mop is satisfied during movement of the main body and based on distance between the cleaning robot and the docking station, transmitting the control signal to the docking station.

The method may include: obtaining information on the distance between the cleaning robot and the docking station based on information obtained through at least on of an ultrasonic sensor, a radar sensor, an infrared sensor, or a light detection or a ranging (LiDAR) sensor.

The method may include: based on determining that the washing condition of the mop being satisfied during movement of the main body and based on at least one of the distance between the cleaning robot and the docking station being less than a preset distance or the estimated time required for the cleaning robot to arrive at the docking station being less than a preset time, transmitting the control signal to the docking station to control the docking station to heat the water to a temperature of water used for washing the mop, and wherein the method is comprising to obtain the estimated time based on the distance and a moving speed of the cleaning robot.

The method may include: based on determining that the washing condition of the mop being satisfied during movement of the main body, (1) transmitting a first control signal to the docking station to control the docking station to heat water to a first temperature, the first temperature being lower than a second temperature of water used for washing the mop; and (2) returning to the docking station; and based on, while the cleaning robot to return to the docking station, at least one of the distance between the cleaning robot and the docking station being less than a preset distance or the estimated time required for the cleaning robot to arrive at the docking station being less than a preset time, transmitting a second control signal to control the docking station to heat the water to the second temperature, wherein the method is comprising to obtain the estimated time based on the distance and a moving speed of the cleaning robot.

The method may include: based on the main body being docked at the docking station, transmitting a third control signal to the docking station to control the docking station to supply a washing tub with the water to wash the mop.

According to embodiments of the disclosure, a non-transitory computer-readable storage medium storing at least one instruction, wherein the at least one instruction, when executed by a processor of a cleaning robot, causes the processor to: perform a cleaning operation by rotating a cleaning pad to which a mop is attached while moving a main body of the cleaning robot based on map data; transmit a control signal to a docking station based on determining that a washing condition of the mop is satisfied during movement of the main body, to control the docking station to heat water to be used for washing the mop; and control the cleaning robot to dock the main body to the docking station.

The method according to the various embodiments disclosed herein may be provided in a computer program product. The computer program product may be traded between a seller and a buyer as a product. The computer program product may be distributed in the form of a machine-readable recording medium (e.g., compact disc read only memory (CD-ROM)), or may be distributed (e.g., download or upload) through an application store (e.g., Play Store^{TM}) online or directly between two user devices (e.g., smartphones). In the case of online distribution, at least a portion of the computer program product (e.g., downloadable app) may be stored at least semi-permanently or may be temporarily generated in a recording medium, such as a memory of a server of a manufacturer, a server of an application store, or a relay server.

Although embodiments of the disclosure have been described with reference to the accompanying drawings, a person having ordinary skilled in the art will appreciate that other specific modifications may be easily made without departing from the technical spirit or essential features of the disclosure. Therefore, the foregoing embodiments should be regarded as illustrative rather than limiting in all aspects.

What is claimed is:

1. A cleaning robot, comprising:
a main body;
a drive assembly configured to move the main body;
a cleaning pad provided at a lower portion of the main body and to which a detachable mop is attached;
a rotating portion configured to rotate the cleaning pad;
memory configured to store map data corresponding to an area for cleaning; and
a processor configured to cause the drive assembly to move the main body based on the map data, and to cause the rotating portion to rotate the cleaning pad to perform a cleaning operation,
wherein the processor is further configured to, based on a washing condition of the mop being satisfied during movement of the main body, cause the cleaning robot to:
transmit a control signal to a docking station to control the docking station to heat water to be used for washing the mop, and
control the cleaning robot to dock the main body to the docking station.

2. The cleaning robot of claim 1, wherein the processor is further configured to cause the cleaning robot to determine that the washing condition of the mop is satisfied based on a size of a cleaned area in the area exceeding a preset size based on the map data.

3. The cleaning robot of claim 1, wherein the processor is further configured to cause the cleaning robot to determine that the washing condition of the mop is satisfied based on a usage time of the cleaning pad exceeding a preset usage time.

4. The cleaning robot of claim 1, wherein the processor is further configured to cause the cleaning robot to determine that the washing condition of the mop is satisfied based on completion of cleaning in the area.

5. The cleaning robot of claim 1, wherein the processor is further configured to cause the cleaning robot to determine that the washing condition of the mop is satisfied based on a washing command for the mop being received via an external device or a user interface.

6. The cleaning robot of claim 1, wherein the processor is further configured to cause the cleaning robot to:
based on a washing condition of the mop being satisfied during movement of the main body, (1) transmit a first control signal to the docking station to control the docking station to heat the water to a first temperature, the first temperature being lower than a second temperature of water used for washing the mop and (2) return to the docking station; and
based on the main body being docked at the docking station, transmit a second control signal to the docking station to control the docking station to (3) heat the water to the second temperature and (4) supply a washing tub with the water having reached the second temperature to wash the mop.

7. The cleaning robot of claim 1, wherein the processor is further configured to cause the cleaning robot to:
based on the washing condition of the mop being satisfied during movement and based on a distance between the cleaning robot and the docking station, transmit the control signal to the docking station.

8. The cleaning robot of claim 7, further comprising:
at least one of an ultrasonic sensor, a radar sensor, an infrared sensor, or a light detection or ranging (LiDAR) sensor, and
wherein the processor is further configured to cause the cleaning robot to obtain information on the distance between the cleaning robot and the docking station based on information obtained through the at least one of the ultrasonic sensor, the radar sensor, the infrared sensor, or the light detection or ranging (LiDAR) sensor.

9. The cleaning robot of claim 7, wherein the processor is further configured to cause the cleaning robot to:
based on the washing condition of the mop being satisfied during movement of the main body and based on at least one of the distance between the cleaning robot and the docking station being less than a preset distance or an estimated time required for the cleaning robot to arrive at the docking station being less than a preset time, transmit the control signal to the docking station to control the docking station to heat the water to a temperature of water used for washing the mop, and
wherein the processor is configured to obtain the estimated time based on the distance and a moving speed of the cleaning robot.

10. The cleaning robot of claim 7, wherein the processor is further configured to cause the cleaning robot to:
based on the washing condition of the mop being satisfied during movement of the main body, (1) transmit a first control signal to the docking station to control the docking station to heat water to a first temperature, the first temperature being lower than a second temperature of water used for washing the mop, and (2) return to the docking station; and
based on, while the cleaning robot returns to the docking station, at least one of the distance between the cleaning robot and the docking station being less than a preset distance or an estimated time required for the cleaning robot to arrive at the docking station being less than a preset time, transmit a second control signal to the docking station to control the docking station to heat the water to the second temperature,
wherein the processor is configured to obtain the estimated time based on the distance and a moving speed of the cleaning robot.

11. The cleaning robot of claim 7, wherein the processor is further configured to cause the cleaning robot to:
based on the main body being docked at the docking station, transmit a third control signal to the docking station to control the docking station to supply a washing tub with the water to wash the mop.

12. A method for controlling a cleaning robot, the method comprising:
rotating a cleaning pad to which a mop is attached while moving a main body of the cleaning robot based on map data;
transmitting a control signal to a docking station based on determining that a washing condition of the mop is satisfied during movement of the main body to control the docking station to heat water to be used for washing the mop; and
driving to the docking station to dock to the docking station.

13. The method of claim 12, further comprising determining the washing condition of the mop is satisfied based on at least one of :
a size of a cleaned area in an area for cleaning of the map data exceeding a preset size,
a usage time of the cleaning pad exceeding a preset usage time,
a completion of cleaning in the cleaning area based on the map data, or
a reception of a washing command for the mop via an external device or a user interface.

14. The method of claim 12, further comprising:
based on determining that the washing condition of the mop is satisfied during movement of the main body, (1)transmitting a first control signal to control the docking station to heat the water to a first temperature, the first temperature being lower than a second temperature of water used for washing the mop and (2) returning to the docking station; and
based on the main body being docked at the docking station, transmitting a second control signal to the docking station to control the docking station to (3) heat the water to the second temperature and(4) supply a washing tub with the water having reached the second temperature to wash the mop.

15. The method of claim 12, further comprising:
based on determining that the washing condition of the mop is satisfied during movement of the main body and based on distance between the cleaning robot and the docking station, transmitting the control signal to the docking station.

16. The method robot of claim 15, further comprising:
obtaining information on the distance between the cleaning robot and the docking station based on information obtained through at least on of an ultrasonic sensor, a radar sensor, an infrared sensor, or a light detection or a ranging (LiDAR) sensor.

17. The method of claim 15, further comprising:
based on determining that the washing condition of the mop being satisfied during movement of the main body and based on at least one of the distance between the cleaning robot and the docking station being less than a preset distance or an estimated time required for the cleaning robot to arrive at the docking station being less than a preset time, transmitting the control signal to the docking station to control the docking station to heat the water to a temperature of water used for washing the mop, and
wherein the method is comprising to obtain the estimated time based on the distance and a moving speed of the cleaning robot.

18. The method of claim 15, further comprising:
based on determining that the washing condition of the mop being satisfied during movement of the main body, (1) transmitting a first control signal to the docking station to control the docking station to heat water to a first temperature, the first temperature being lower than a second temperature of water used for washing the mop and (2) returning to the docking station; and
based on, while the cleaning robot to return to the docking station, at least one of the distance between the cleaning robot and the docking station being less than a preset distance or an estimated time required for the cleaning robot to arrive at the docking station being less than a preset time, transmitting a second control signal to control the docking station to heat the water to the second temperature,
wherein the method is comprising to obtain the estimated time based on the distance and a moving speed of the cleaning robot.

19. The method of claim 18, further comprising:
based on the main body being docked at the docking station, transmitting a third control signal to the docking station to control the docking station to supply a washing tub with the water to wash the mop.

20. A non-transitory computer-readable storage medium storing at least one instruction, wherein the at least one instruction, when executed by a processor of a cleaning robot, causes the processor to:
perform a cleaning operation by rotating a cleaning pad to which a mop is attached while moving a main body of the cleaning robot based on map data;
transmit a control signal to a docking station based on determining that a washing condition of the mop is satisfied during movement of the main body, to control the docking station to heat water to be used for washing the mop; and
control the cleaning robot to dock the main body to the docking station.
